(19) United States
(12) Patent Application Publication
(10) Pub. No.: US 2013/0160006 A1
(43) Pub. Date: Jun. 20, 2013

(54) APPARATUS AND METHOD FOR CONTROLLING SENSOR DATA IN CLOUD SYSTEM

(71) Applicants: Jin-Hwan JEONG, Seoul (KR); Hag-Young Kim, Daejeon (KR); Chang-Soo Kim, Daejeon (KR); Yong-Ju Lee, Daejeon (KR); Choon-Seo Park, Daejeon (KR); Joong-Soo Lee, Daejeon (KR); Jung-Hyun Cho, Daejeon (KR)

(72) Inventors: Jin-Hwan JEONG, Seoul (KR); Hag-Young Kim, Daejeon (KR); Chang-Soo Kim, Daejeon (KR); Yong-Ju Lee, Daejeon (KR); Choon-Seo Park, Daejeon (KR); Joong-Soo Lee, Daejeon (KR); Jung-Hyun Cho, Daejeon (KR)

(73) Assignee: ELECTRONICS AND TELECOMMUNICATIONS RESEARCH INSTITUTE, Daejeon (KR)

(21) Appl. No.: 13/524,061

(22) Filed: Jun. 15, 2012

(30) Foreign Application Priority Data
Dec. 15, 2011 (KR) 10-2011-0135910

(51) Int. Cl. G06F 9/455; G06F 15/16

(52) U.S. Cl. 718/1

(57) ABSTRACT

Disclosed herein is an apparatus for controlling sensor data in a cloud system. The apparatus includes a plurality of virtual machines, and a service module. Each of the plurality of virtual machines obtains sensor information about a user terminal by driving an internal sensor data processing module at a request of the corresponding user terminal, and provides the application execution environment of a requested service by connecting to the user terminal over a network. The service module provides an application corresponding to the requested service to a virtual machine which requested the service. When a sensor Application Programming Interface (API) of the user terminal is called by the application, the virtual machine requests sensor data from the user terminal based on the sensor information about the user terminal, and provides the result of measurement of the sensor data from the user terminal to the corresponding application.

### CROSS REFERENCE TO RELATED APPLICATION

This application claims the benefit of Korean Patent Application No.10-2011-0135910, filed on Dec. 15, 2011, which is hereby incorporated by reference in its entirety into this application.

### BACKGROUND OF THE INVENTION

1. Technical Field

The present invention relates generally to an apparatus and method for controlling sensor data in a cloud system, and, more particularly, to an apparatus and method for controlling sensor data in a cloud system, which provides sensor data, called by an application, to the corresponding application using a virtual machine connected to a user terminal over a network.

2. Description of the Related Art

A cloud system includes applications for providing services, service virtual machines for performing and managing requested services, cloud server operating systems and devices for managing the virtual machines, and other management servers.

When a user terminal requests a specific service, the cloud system determines whether there is a virtual machine corresponding to the user terminal which requested the service. If there is a virtual machine corresponding to the user terminal, the virtual machine configures a connection to the user terminal over a network, and then executes an application corresponding to the requested service.

Meanwhile, in the cloud system, in order to obtain the value of the sensor device of a corresponding user terminal when a service is being provided, a service developer tries to separately connect to the user terminal and directly implements control of the sensor device of the corresponding user terminal and transmission of sensor data.

However, such a method burdens service developers and the implementation thereof contains redundancy because each developer individually performs the method.

Further, in the past, even when a virtual machine is connected to a user terminal in advance over a network, each service developer had to individually try to access the user terminal.

In addition, although sensor information about a user terminal has been stored in a cloud system during the process of constructing a network between a user terminal and a virtual machine, there is an inconvenience in that, when an application requires sensor data, a mobile service developer should implement a module for obtaining the sensor data.

### SUMMARY OF THE INVENTION

Accordingly, the present invention has been made keeping in mind the above problems occurring in the prior art, and an object of the present invention is to provide an apparatus and method for controlling sensor data in a cloud system, which enables an application to easily obtain the sensor data about a user terminal by providing the sensor data, called by the application, to the corresponding application using a virtual machine connected to the user terminal over a network.

Another object of the present invention is to provide an apparatus and method for controlling sensor data in a cloud system, which, when an application developer obtains a sensor Application Program Interface (API), enables the application developer to easily obtain the sensor API using a virtual machine without separately connecting to a user terminal over a network.

In order to accomplish the above object, the present invention provides an apparatus for controlling sensor data in a cloud system, the apparatus including a plurality of virtual machines for each obtaining sensor information about a user terminal by driving an internal sensor data processing module at a request of the corresponding user terminal, and providing the application execution environment of a requested service by connecting to the user terminal over a network; and a service module for providing an application corresponding to the requested service to a virtual machine which requested the service from among the plurality of virtual machines.

Here, when the sensor Application Programming Interface (API) of the user terminal is called by the application, the virtual machine requests sensor data from the user terminal based on the sensor information about the user terminal, and provides the result of measurement of the sensor data from the user terminal to the corresponding application.

The sensor data processing module may be implemented in the kernel module of the virtual machine.

If the sensor API of the user terminal is called by the application when the corresponding application is being executed, the sensor data processing module may generate a sensor API packet based on the sensor information.

The virtual machine may transmit the sensor API packet generated by the sensor data processing module to the user terminal which corresponds to the virtual machine.

The sensor data processing module may construct a resulting API related to the result of measurement of the sensor data which was received from the user terminal.

The virtual machine may provide the resulting API constructed by the sensor data processing module to the corresponding application.

Meanwhile, in order to accomplish another object, the present invention provides a method of controlling sensor data in a cloud system which includes a plurality of virtual machines each corresponding to a user terminal and providing an application service, the method including obtaining sensor information about the user terminal by driving an internal sensor data processing module at the request of the corresponding user terminal using the virtual machine; executing an application corresponding to a requested service by connecting to the user terminal over a network using the virtual machine; when the sensor API of the user terminal is called by the application, requesting sensor data from the user terminal based on the sensor information about the user terminal using the virtual machine; and providing the result of measurement of the sensor data from the user terminal to the corresponding application using the virtual machine.

The sensor data processing module may be implemented in the kernel module of the virtual machine.

The method may further include, if the sensor API of the user terminal is called by the corresponding application when the application is being executed, generating a sensor API packet based on the sensor information about the user terminal using the sensor data processing module.

The requesting the sensor data may include transmitting the sensor API packet, generated at the generating the sensor API packet, to the corresponding user terminal.

The method may further include, if the result of measurement of the sensor data is received from the user terminal, constructing a resulting API related to the result of measurement of the sensor data using the sensor data processing module.

The providing the result of measurement of the sensor data may include providing the resulting API, obtained at the constructing the resulting API, to the corresponding application.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a view illustrating the configuration of the sensor data control apparatus of a cloud system according to the present invention;

FIG. 2 is a view illustrating the operation of the sensor data control apparatus of the cloud system according to the present invention; and

FIGS. 3 and 4 are flowcharts illustrating the flow of the operation of a sensor data control method performed in the cloud system according to the present invention.

### DESCRIPTION OF THE PREFERRED EMBODIMENTS

Reference now should be made to the drawings, throughout which the same reference numerals are used to designate the same or similar components.

Embodiments of the present invention will be described with reference to the accompanying drawings below.

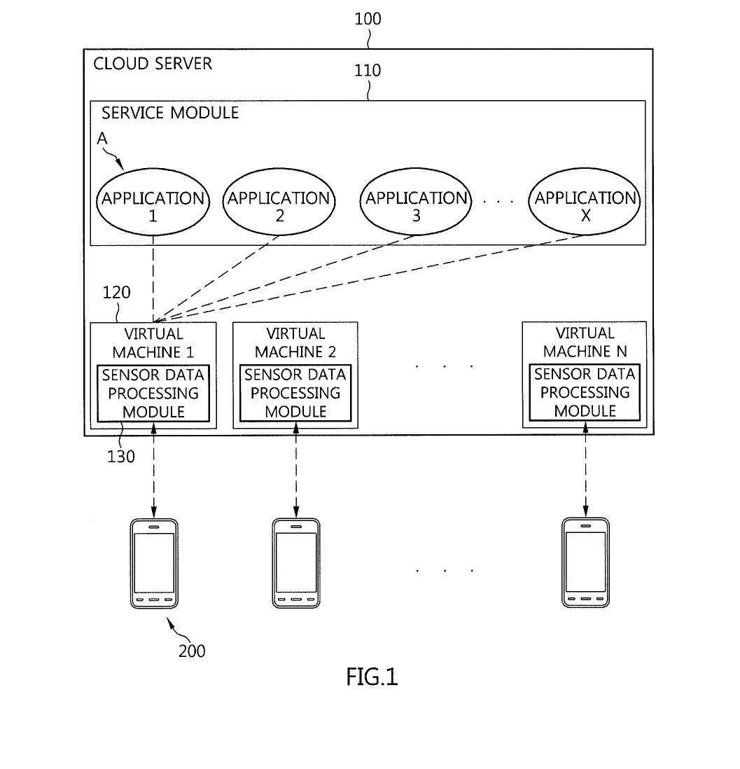

FIG. 1 is a view illustrating the configuration of the sensor data control apparatus of a cloud system according to the present invention.

As shown in FIG. 1, the sensor data control apparatus of the cloud system according to the present invention includes a service module 110 and a plurality of virtual machines 120.

The service module 110 includes a plurality of applications A, and provides an application A corresponding to a requested service to a virtual machine 120 which requested the service from among the plurality of virtual machines 120.

The plurality of virtual machines 120 correspond to a plurality of user terminals 200, respectively. That is, when a user terminal 200 accesses the cloud system, the cloud system generates a virtual machine 120 corresponding to the relevant user terminal 200.

Here, the generated virtual machine 120 obtains sensor information about the user terminal 200 by driving an internal sensor data processing module 130, and then provides the application execution environment of the requested service by connecting to the user terminal 200 over a network. The virtual machine 120 is connected to the user terminal 200 one-to-one over the network.

The sensor information about the user terminal 200, which was obtained when the virtual machine 120 is connected to the user terminal 200 over the network, is stored in the cloud server 100.

When any one of applications A is requested by the user terminal 200, the virtual machine 120 requests the corresponding application A from the service module 110. When the service module 110 provides the corresponding application A, the corresponding application A is executed in the virtual machine 120.

When the application A is requested to be executed or when the application A is being executed, a case may occur in which sensor information is required depending on an execution environment. In this case, the application A calls the virtual machine 120 for a sensor Application Programming Interface (API). Therefore, since the sensor information about the user terminal 200 which is connected to over the network has been previously stored in the cloud server 100, the virtual machine 120 requests sensor data from the user terminal 200 which is connected to over the network based on the previously stored sensor information about the user terminal 200.

Of course, the virtual machine 120 determines whether the sensor API call performed by the application A is a sensor API call for the user terminal 200. If the sensor API call performed by the application A is not the sensor API call for the user terminal 200, the virtual machine 120 executes the corresponding application A, and then provides a resulting API to the application A.

Meanwhile, if it is determined that the sensor API call performed by the application A is the sensor API call for the user terminal 200, the virtual machine 120 requests sensor data from the user terminal 200 which is connected to over the network based on the previously stored sensor information about the user terminal 200.

In this case, the virtual machine 120 drives the internal sensor data processing module 130. Here, the sensor data processing module 130 is implemented in the kernel module of the virtual machine 120. The internal sensor data processing module 130 of the virtual machine 120 generates a sensor API packet based on the sensor information about the user terminal 200 which has been stored in the cloud server 100.

As an example, if Global Positioning System (GPS) information about the user terminal 200 is called by a map application A when the corresponding map application A is being executed, the sensor data processing module of the virtual machine 120 generates a sensor API packet for the GPS module of the sensor information about the user terminal 200 which has been stored in the cloud server 100.

When the sensor API packet is generated by the sensor data processing module 130, the virtual machine 120 transmits the generated sensor API packet to the user terminal 200 which is connected to over the network.

When the sensor API packet is received from the virtual machine 120 which is connected to over the network, the user terminal 200 controls a corresponding sensor based on the sensor API information of the received packet. Therefore, the user terminal 200 transmits the result of measurement of the corresponding sensor data to the virtual machine 120 which is connected to over the network.

As an example, if the received sensor API packet is related to the GPS module, the user terminal 200 drives the GPS module of the user terminal 200 based on GPS module information included in the corresponding packet, and then transmits the result of measurement of GPS data, obtained by driving the GPS module, to the virtual machine 120 which is connected to over the network.

If the result of measurement of the sensor data is received from the corresponding user terminal 200 in response to the sensor API packet transmitted to the user terminal 200 which is connected to over the network, the sensor data processing module 130 of the virtual machine 120 constructs a resulting API related to the result of measurement of the sensor data received from the user terminal 200. The virtual machine 120 provides the resulting API constructed by the sensor data processing module 130 to the corresponding application A.

Therefore, the application A can receive the resulting API from the virtual machine 120 by only calling the virtual machine 120 for the sensor API related to necessary sensor information, and can apply sensor data included in the resulting API which was provided from the virtual machine 120.

In such a way, when an application developer obtains sensor data in order to generate or update the application A of the user terminal 200, the application developer can obtain the corresponding sensor data by only calling the virtual machine 120 for a necessary sensor API without trying to connect to the corresponding user terminal 200 over an additional network or separately implementing the control of the sensor of the user terminal 200.

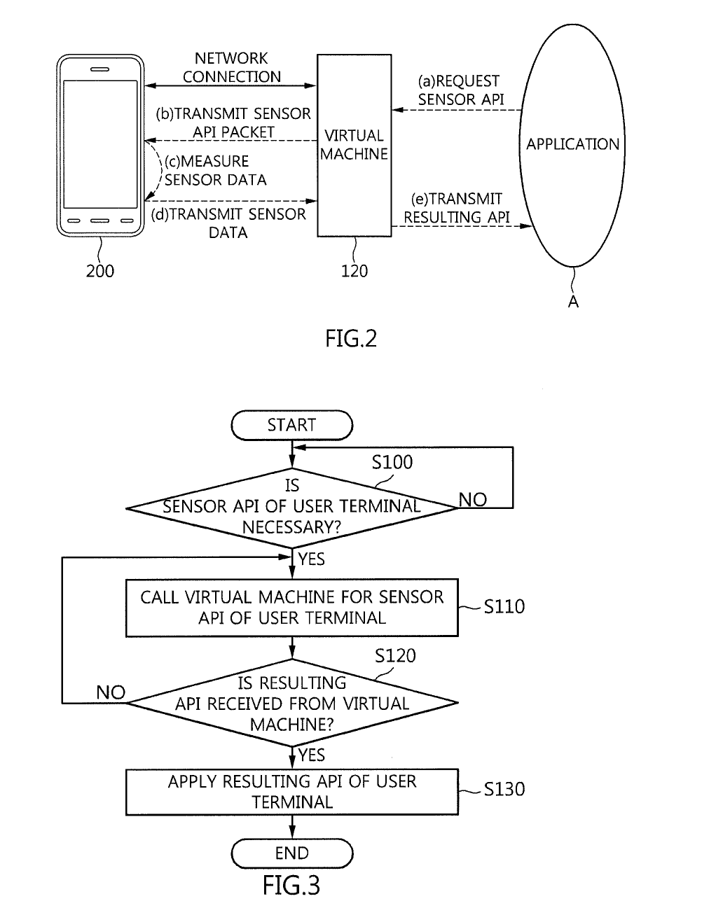

FIG. 2 is a view illustrating the operation of the sensor data control apparatus of the cloud system according to the present invention.

As shown in FIG. 2, if sensor data is required to execute an application A in the state in which the user terminal 200 is connected to the virtual machine 120 in advance over a network, the application A can request a sensor API from the virtual machine 120 as shown in (a) of FIG. 2.

When the application A requests a sensor API, the virtual machine 120 packetizes the sensor API requested by the application A based on sensor information transmitted from the user terminal 200 during the process of connecting to the user terminal 200 over the network, and then transmits a sensor API packet to the to the user terminal 200 which is connected to over the network, as shown in (b) of FIG. 2.

Here, the user terminal 200 controls and drives a corresponding sensor based on the sensor API information of the sensor API packet received in (b) of FIG. 2, and then measures sensor data by driving the corresponding sensor as in (c) of FIG. 2. When the sensor data is measured, the user terminal 200 transmits the result of the measurement of the sensor data to the virtual machine 120 as in (d) of FIG. 2.

When the result of the measurement of the sensor data is received from the user terminal 200, the virtual machine 120 provides the corresponding information to the application A as in (e) of FIG. 2. Here, a resulting API related to the result of the measurement of the sensor data received from the user terminal 200 is constructed by driving the internal sensor data processing module of the virtual machine 120, and then the resulting API constructed by the sensor data processing module is provided to the corresponding application A.

The flow of the operation of the sensor data control apparatus of the cloud system, which is constructed as described above, is as follows.

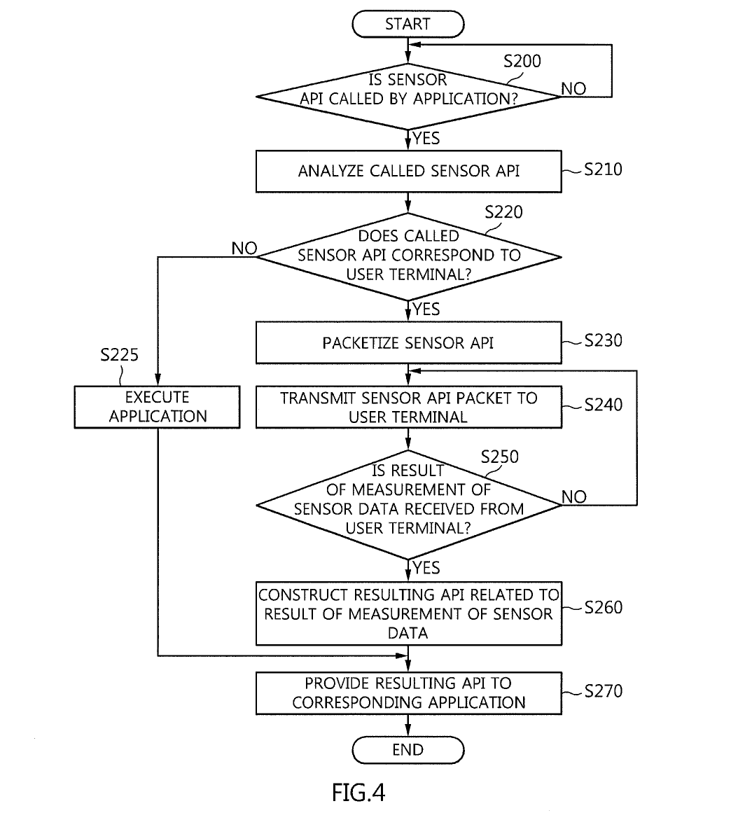

FIGS. 3 and 4 are flowcharts illustrating the flow of the operation of a sensor data control method performed by the cloud system according to the present invention.

First, FIG. 3 is a flowchart illustrating the flow of the operation of an application in the cloud system according to the present invention. FIG. 3 will be described on the assumption that a user terminal is connected to a relevant virtual machine over a network in advance, and sensor information about the user terminal is stored in the cloud system, that is, the cloud server.

As shown in FIG. 3, the application is executed at the request of the virtual machine. When the sensor API of the user terminal is required to execute the corresponding application when the virtual machine requests the execution of the application at step S100, the application calls the virtual machine for a sensor API related to necessary sensor data at step S110.

Of course, if additional sensor data about the user terminal is necessary, the application can call the virtual machine for the sensor API even when the corresponding application is being executed in addition to when the application is requested to be executed.

Thereafter, the application waits for a resulting API to be received from the virtual machine. When the resulting API is received from the virtual machine at step S120, the resulting API of the user terminal, which was received at step S120, is applied to the corresponding application at step S130.

Of course, if the resulting API is not received from the virtual machine for a predetermined time period or longer, the application can call again the virtual machine for the sensor API of the user terminal.

Meanwhile, FIG. 4 is a flowchart illustrating the flow of the operation of the virtual machine of the cloud system according to the present invention. Like FIG. 3, FIG. 4 will be described on the assumption that the user terminal is connected to the corresponding virtual machine over a network in advance, and the sensor information about the user terminal is stored in the cloud system, that is, the cloud server.

As shown in FIG. 4, when a sensor API is called by an application corresponding to a requested service at step S200, the virtual machine analyzes the called sensor API at step S210.

If, as a result of the analysis at step S210, the sensor API called by the application is not a sensor API call for the user terminal at step S220, the virtual machine executes the corresponding application at step S225, and provides a resulting API related to the result of the execution of the application to the application at step S270.

Meanwhile, if, as the result of the analysis at step S210, the sensor API called by the application is the sensor API call for the user terminal at step S220, the virtual machine packetizes the corresponding sensor API based on the sensor information which has been stored in the cloud server at step S230, and then transmits a sensor API packet to the user terminal which is previously connected to over the network at step S240.

Here, if the sensor API of the user terminal is called by the application, the virtual machine drives the sensor data processing module implemented in the internal kernel module, and a procedure at step S230 is performed by the sensor data processing module driven at this time.

Meanwhile, if the result of measurement of the sensor data is received from the user terminal at step S250, the virtual machine constructs the resulting API related to the result of measurement of the sensor data at step S260, and then provides the resulting API obtained at step S260 to the corresponding application at step S270.

Here, a procedure at step S260 is performed by the internal sensor data processing module of the virtual machine.

Further, if the result of measurement of the sensor data is not received from the user terminal for a predetermined time period or longer after the procedure at step S240 has been performed, the virtual machine can perform the procedure at step S240 again.

Therefore, the application can receive the resulting API from the virtual machine through the procedure at step S270, and can apply the sensor data included in the resulting API which was received from the virtual machine.

According to the present invention, a virtual machine which is connected to a user terminal over a network provides sensor data called by an application to the corresponding application, so that there is an advantage in that an application can easily obtain sensor data about the user terminal.

Further, according to the present invention, there is another advantage in that, when an application developer obtains a sensor API, the application developer can easily obtain the sensor API using a virtual machine without separately connecting to a user terminal over a network.

Although the preferred embodiments of an apparatus and method for controlling sensor data in a cloud system according to the present invention have been disclosed for illustrative purposes, those skilled in the art will appreciate that various modifications, additions and substitutions are possible, without departing from the scope and spirit of the invention as disclosed in the accompanying claims.

What is claimed is:

1. An apparatus for controlling sensor data in a cloud system, the apparatus comprising:
a plurality of virtual machines for each obtaining sensor information about a user terminal by driving an internal sensor data processing module at a request of the corresponding user terminal, and providing an application execution environment of a requested service by configuring a connection to the user terminal over a network; and
a service module for providing an application corresponding to the requested service to a virtual machine which requested the requested service from among the plurality of virtual machines,
wherein the virtual machine requests sensor data from the user terminal based on the sensor information about the user terminal when a sensor Application Programming Interface (API) of the user terminal is called by the application, and provides a result of measurement of the sensor data from the user terminal to the application.

2. The apparatus as set forth in claim 1, wherein the sensor data processing module is implemented in a kernel module of the virtual machine.

3. The apparatus as set forth in claim 1, wherein, if a sensor API of the user terminal is called by the application when the application is being executed, the sensor data processing module generates a sensor API packet based on the sensor information.

4. The apparatus as set forth in claim 3, wherein the virtual machine transmits the sensor API packet generated by the sensor data processing module to the user terminal which corresponds to the virtual machine.

5. The apparatus as set forth in claim 1, wherein the sensor data processing module constructs a resulting API related to a result of measurement of the sensor data which was received from the user terminal.

6. The apparatus as set forth in claim 5, wherein the virtual machine provides the resulting API constructed by the sensor data processing module to the application.

7. A method of controlling sensor data in a cloud system which includes a plurality of virtual machines each of which corresponds to a user terminal and provides an application service, the method comprising:
obtaining, by the virtual machine, sensor information about the user terminal by driving an internal sensor data processing module at a request of the corresponding user terminal;
executing, by the virtual machine, an application corresponding to a requested service by configuring a connection to the user terminal over a network;
when a sensor API of the user terminal is called by the application, requesting, by the virtual machine, sensor data from the user terminal based on the sensor information about the user terminal; and
providing a result of measurement of the sensor data from the user terminal to the application.

8. The method as set forth in claim 7, wherein the sensor data processing module is implemented in a kernel module of the virtual machine.

9. The method as set forth in claim 7, further comprising:
if a sensor API of the user terminal is called by the application when the application is being executed, generating a sensor API packet based on the sensor information about the user terminal using the sensor data processing module.

10. The method as set forth in claim 9, wherein the requesting the sensor data comprises transmitting the sensor API packet, generated at the generating the sensor API packet, to the corresponding user terminal.

11. The method as set forth in claim 7, further comprising:
if a result of measurement of the sensor data is received from the user terminal, constructing a resulting API related to the result of measurement of the sensor data using the sensor data processing module.

12. The method as set forth in claim 11, wherein the providing the result of measurement of the sensor data comprises providing the resulting API, obtained at the constructing the resulting API, to the application.
